(19) United States
(12) Patent Application Publication
(10) Pub. No.: US 2014/0064828 A1
(43) Pub. Date: Mar. 6, 2014

(54) Systems and Methods for Securing Mobile Medical Equipment Supporter Systems to Patient Transporters with Adjustability

(71) Applicant: Randall D. Hilton, Castro Valley, CA (US)

(72) Inventor: Randall D. Hilton, Castro Valley, CA (US)

(21) Appl. No.: 14/010,447

(22) Filed: Aug. 26, 2013

Related U.S. Application Data
(63) Continuation-in-part of application No. 13/225,091, filed on Sep. 2, 2011.

(51) Int. Cl. A61G 7/05; F16B 7/10

(52) U.S. Cl. CPC A61G 7/05; F16B 7/10
USPC 403/80; 403/66

(57) ABSTRACT

The present invention relates to systems and methods for securing a mobile medical equipment supporter system, such as an infusion pump pole, to a mobile patient transporter, such as a gurney, thereby enhancing patient and attendant safety. In some embodiments in accordance with the present invention adjustable hitchee assembly is operatively connected to a hitch coupler of the mobile medical equipment supporter system which allows the position where the mobile medical equipment supporter system is secured to the mobile patient transporter to be easily varied. In some other embodiments in accordance with the present invention more than one mobile medical equipment supporter system can be secured independently to the mobile patient transporter. In yet another embodiment, the mobile medical equipment supporter system can be configured to be positioned at any desired position around the mobile patient transporter.

### CROSS REFERENCE TO RELATED APPLICATIONS

This is a continuation-in-part and claims benefit of U.S. application Ser. No. 13/225,091 filed on Sep. 2, 2011, entitled “Systems and Methods for Securing Mobile Medical Equipment Supporter Systems to Patient Transporters”, which application is hereby fully incorporated by this reference.

### BACKGROUND

The present invention relates to systems and methods for securing a mobile medical equipment supporter system, such as an infusion pump pole, to a mobile patient transporter, such as a gurney, thereby enhancing patient and attendant safety and convenience.

In a healthcare provider environment, it is common for a patient to be attached to an intravenous (IV) line and often also attached to the leads of one or more monitoring devices. The patient is typically resting on a rollable bed or gurney or seated on a wheelchair for their safety or out of necessity.

Generally in the case of a bed or gurney, for safety reasons, two attendants, typically aides or nurses, with one attendant positioned at each end, guide and propel the bed or gurney from one location to another location, for example, from the operating recovery room to the patient's room. Often, the attendant at the head of the bed or gurney may also be responsible for guiding and propelling a mobile infusion pump pole supporting the IV line, leaving only one hand to push and guide the bed. As a result, the safety of both the patient and/or the attendants is potentially compromised by increasing the risk of collisions and/or tipping over the mobile infusion pole.

Similarly, when a patient is in a wheelchair and also coupled to an IV line and/or a monitoring device, instead of a single attendant responsible for pushing the wheelchair, two attendants are now probably required; with one attendant responsible for propelling the wheelchair, and the second attendant responsible for propelling the mobile infusion pump pole.

It is therefore apparent that an urgent need exists for systems and methods for operatively coupling a mobile medical equipment supporter system to a mobile patient transporter. This improved coupling enables attendants to safely and efficiently transport patients from one location to another in healthcare provider settings.

### SUMMARY

To achieve the foregoing and in accordance with the present invention, systems and methods for securing a mobile medical equipment supporter system to a mobile patient transporter is provided. In particular, a hitcher coupler and a hitchee coupler are provided for securing a mobile medical supporter system to a mobile patient transporter thereby enhancing patient and attendant safety and convenience.

In one embodiment, the supporter system includes a substantially vertical primary support structure, one or more attachment points configured to secure medical delivery device(s) and/or medical monitoring device(s), a wheeled mobility assembly, and a hitcher assembly having a hitcher coupler configured to operatively mate with a corresponding hitchee coupler of the mobile patient transporter. The hitcher coupler can be male and the corresponding hitchee coupler can be female, and both the hitcher coupler and the hitchee coupler can have circular cross-sectional profiles. In some embodiments, the mobility assembly includes a carousel and three or more wheeled extensions rotatably attached to the carousel.

The coupling process starts by increasing the relative height between the supporter system and the patient transporter. Next, the hitcher coupler of the supporter system is aligned to the hitchee coupler of the patient transporter along a substantially vertical axis. The hitcher coupler is then securely engaged to the hitchee coupler by decreasing the relative height between the supporter system and the patient transporter, thereby enabling the patient transporter to be propelled without a need to separately propel the supporter system.

In some embodiments, increasing the relative height includes lowering the height of the patient transporter, and engaging the hitcher coupler to the hitchee coupler includes raising the height of the patient transporter. The footprint of the supporter system can also be reduced by further increasing the height of the patient transporter, thereby enhancing maneuverability.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a front view of one embodiment of a mobile medical equipment supporter system configured to couple with a patient transporter in accordance with the present invention;

FIG. 2 shows the embodiment of FIG. 1 coupled to one end of a patient transporter;

FIG. 3 illustrates a portion of another embodiment of a mobile medical equipment supporter having a hitcher coupler configured to operatively mate with a patient transporter, wherein the hitcher coupler is female and the hitchee coupler is male;

FIG. 4 illustrates yet another embodiment wherein the hitcher coupler is female and a hitchee coupler is male;

FIGS. 5 and 6 are bottom views of additional embodiments of hitcher couplers with cross-sectional profiles that are polygonal;

FIG. 7 is an isometric view showing an embodiment of corresponding hitcher assembly and hitchee assembly, suitable for retrofitting a conventional mobile medical supporter system and an incompatible patient transporter, respectively;

FIG. 8 shows a portion of yet another embodiment of a hitcher assembly having a clamping attachment for attaching to a mobile medical supporter system;

FIGS. 9 and 10 show portions of two additional embodiments of hitcher assemblies suitable for attaching to mobile medical supporter systems;

FIGS. 11 and 12 are a side view and a front view, respectively, showing additional embodiments of attachment points suitable for the supporter system of FIG. 1;

FIGS. 13 is a prospective view of one embodiment in which a patient transporter is operatively coupled to a mobile medical equipment supporter system by an adjustable hitchee coupler in accordance with the present invention;

FIG. 13A is a blow-up prospective view of one edge of the adjustable hitchee coupler;

FIG. 13B is a blow-up of a U-bracket operatively attaching the adjustable hitchee coupler the patient transporter;

FIG. 13C is a blow-up of a ball detent pin locking the adjustable hitchee coupler in position;

FIGS. 14A, 14B, and 14C illustrate three side views for the end of the patient transporter and the adjustable hitchee coupler at three different positions;

FIG. 15 depicts a side view of one embodiment in accordance with the present invention for two independent adjustable hitchee couplers operatively coupled to the patient transporter;

FIG. 16 shows a bottom view of another embodiment for two independent adjustable hitchee couplers operatively coupled under the patient transporter;

FIG. 17A represents a bottom view of yet another embodiment for a variable position adjustable hitchee couplers operatively coupled underneath the patient transporter;

FIG. 17B shows a blown-up view of the adjustable hitchee couplers for the embodiment depicted in FIG. 17A; and

FIGS. 18 and 19 illustrate the upper portions of two additional embodiments of the equipment supporter systems in accordance with the present invention.

### DETAILED DESCRIPTION

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute terms, such as, for example, “will,” “will not,” “shall,” “shall not,” “must,” and “must not,” are not meant to limit the scope of the present invention as the embodiments disclosed herein are merely exemplary.

The present invention relates to systems and methods for securing a mobile medical supporter system to a mobile patient transporter thereby enhancing patient and attendant safety and convenience.

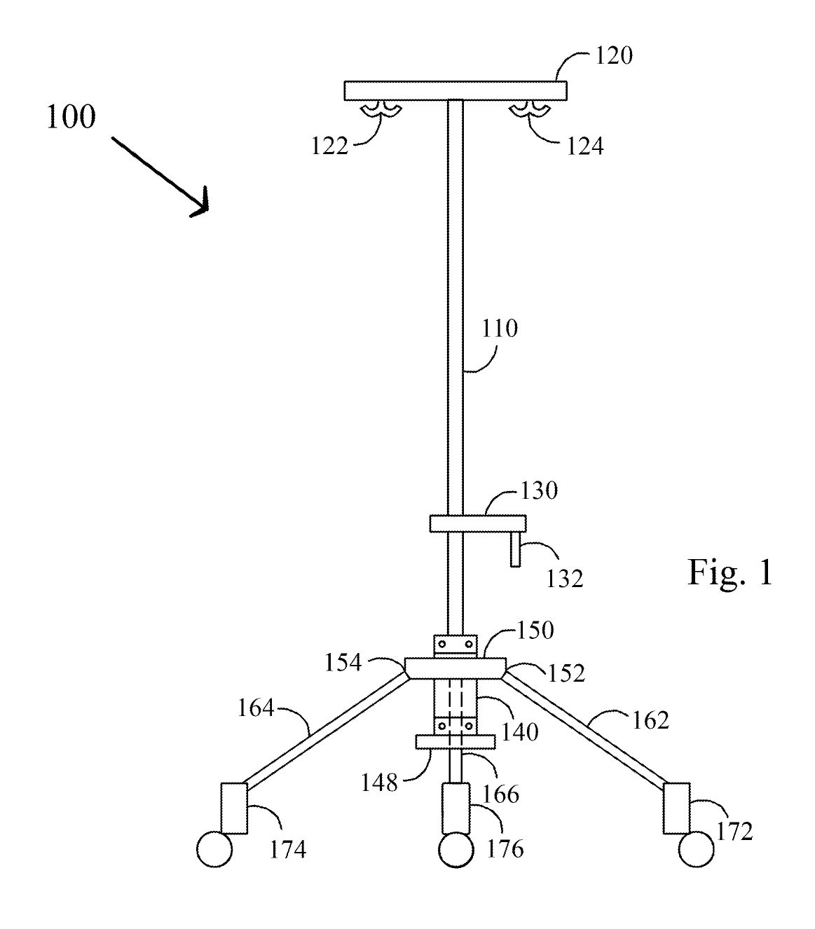

To facilitate discussion, FIG. 1 illustrates one embodiment of a mobile medical equipment supporter system 100 in accordance with the present invention. Supporter system 100 includes a substantially vertical primary support structure 110, an attachment bar 120, a hitcher assembly 130, a supporter base 140 with a base plate 148, a mobility assembly with a carousel 150 and three or more legs 162, 164, 166 attached to castor wheels 172, 174, 176, respectively.

Attachment bar 120 includes one of more attachment points 122, 124. Each attachment point is configured to support one or more medical delivery devices such as an IV pouch and/or one or more medical monitoring devices, such as a heart rate monitor and/or a BP monitor.

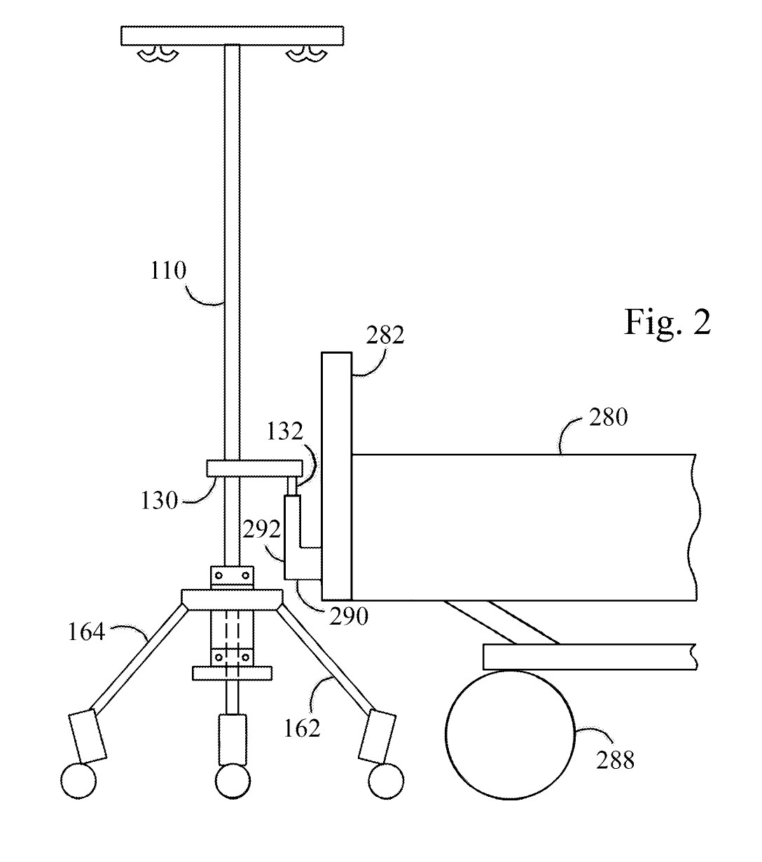

Hitcher assembly 130 includes a hitcher coupler 132 configured to operatively couple the supporter system 100 to an existing or retrofitted hitchee coupler 292 attached to one end of a mobile patient transporter 280 as shown in FIG. 2.

Carousel 150 includes corresponding slots with pivot pins (not shown) at leg pivoting locations, e.g., pivot locations 152, 154, for supporting rotatable legs 162, 164. While these three legs 162, 164, 166 should provide sufficient stability for many applications and environments, increasing the number of legs, e.g., to six legs, should increase stability substantially by increasing the number of contact points with the ground and also by lowering the center of gravity of supporter system 100.

Referring again to FIG. 2, mobile supporter system 100 is operatively coupled to a headboard 282 of a patient transporter 280. This is accomplished by coupling hitcher coupler 132 of hitcher assembly 130 to a corresponding tubular hitchee coupler 292 of hitchee assembly 290.

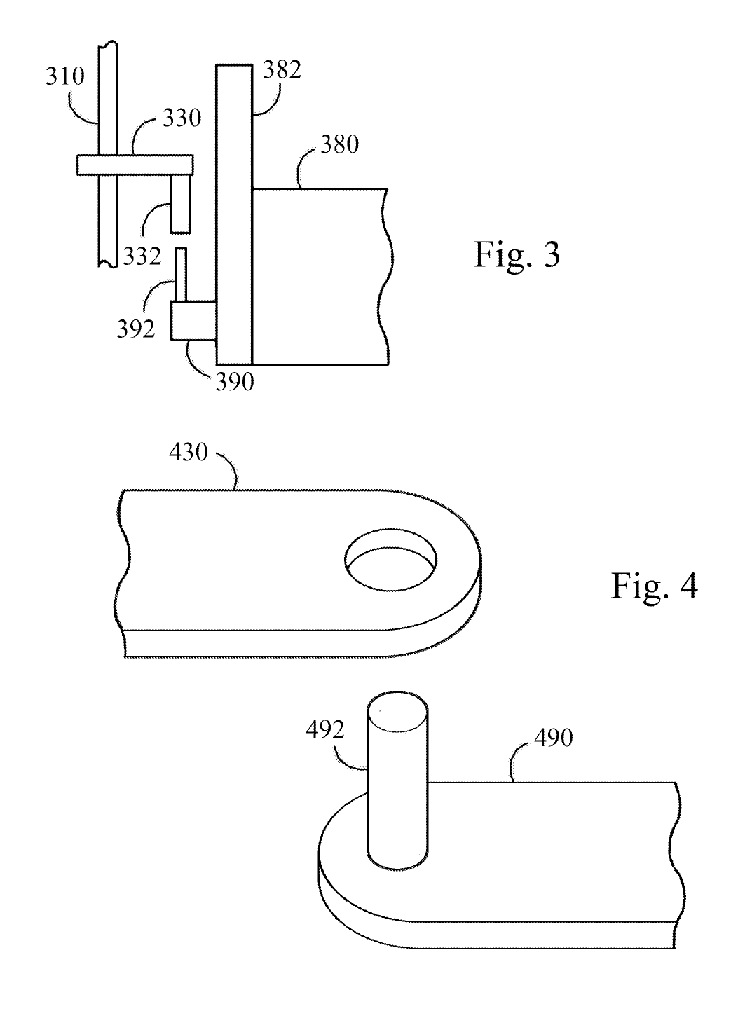

Note that although in the above-described example, hitcher coupler 132 is male and hitchee coupler 292 is female, the reverse configuration is also possible, i.e., wherein hitcher coupler 332 is female (e.g., tube-shaped) and hitchee coupler 392 is male (e.g., rod-shaped) as shown in FIG. 3.

In this embodiment, as discussed above, legs 162, 164, 166 can independently pivot like a hinge at the respective pivoting locations of carousel 150, allowing equipment supporter system 100 to be raised and lowered vertically while maintaining contact between wheels 172, 174, 176 with the ground, thereby substantially reducing the risk of tipping supporter system 110. Similarly, in most embodiments, for attendant and patient safety reasons, the height of patient transporter 280 can be raised and lowered, e.g., via a hydraulically and/or mechanically assisted system (not shown).

Accordingly, coupling of hitcher coupler 132 to hitchee coupler 292 can be accomplished efficiently and quickly in the following manner. Patient transporter 280 is lowered so that the height of the opening of hitchee coupler 292 is below that of the tip of hitcher coupler 132. The equipment supporter system 100 can now be wheeled so that hitcher coupler 132 and hitcher coupler 292 are aligned in the vertical axis. Hitchee coupler 292 can now be mated with hitcher coupler 132 by raising patient transporter 280. It is possible to reduce the footprint of supporter system 100 by raising the patient transporter 280 further so that the legs 162, 164, 166 are pivoted inwards, e.g. reducing the overall leg spread from about 22 inches to about 16 inches, thereby improving the maneuverability characteristics of the transporter 280 and supporter system 100 combination through hallways and entryways.

Similarly, during the decoupling process, the patient transporter 280 can be lowered to clear the hitchee coupler 292 from hitcher coupler 132, while lowering equipment supporter system 100 back into its spread-leg position and separating supporter system 100 from the patient transporter 280.

It may also be possible to engage equipment supporter system 100 with patient transporter 280, by vertically raising and then lowering supporter system 100, thereby inserting hitcher coupler 132 into hitchee coupler 292. Similarly, during the decoupling process, the supporter system 100 is raised vertically to clear the hitcher coupler 132 from hitchee coupler 292 and then lowered back into its full spread-leg position, thereby separating supporter system 100 from the patient transporter 280. Ideally, attendant safety can be enhanced by provided supporter system 100 with hydraulic and/or mechanical assistance during the raising and lowering of system 100.

Alternatively, in other embodiments, instead of securing hitcher assembly 130 at a fixed location on primary support structure 110, hitcher assembly 130 is configured to slide along support structure 110, thereby simplify the leg design, since legs 162, 164, 166 will no longer need to pivot during the coupling and decoupling processes. Instead, once the hitcher coupler 132 is inserted into hitchee coupler 292, hitcher assembly 130 can be secured at a desired height on support structure 110.

Several modifications can also be made to aid in the coupling process between hitcher assembly 130 and hitchee assembly 290. For example, the end of male hitcher coupler 132 can be a ball-end and/or the opening of female hitchee coupler 292 can be chamfered.

Other modifications are also possible. As shown in FIG. 4, hitcher assembly 430 can be a plate with a round hole serving as a hitcher coupler, while hitchee assembly 490 can include a rod-shaped hitchee coupler 492. Assuming that the supporter system is stable, such a system will permit a limited amount of relative horizontally movement between the supporter system 100 and the patient transporter 280, e.g., when travelling up or down a ramp.

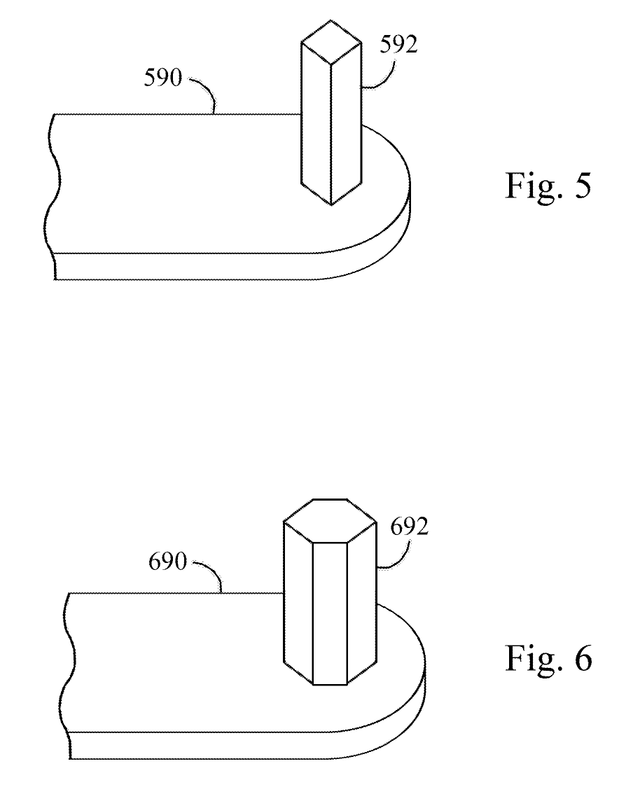

Additional modifications contemplated are illustrated by FIGS. 5 and 6, which are bottom views of alternate embodiments of hitcher/hitchee assemblies for mobile supporter systems. For example, by substituting the circular cross-sectional hitcher coupler 132 with a square cross-sectional hitcher coupler 592, and with a square cross-sectional profile change to a corresponding female hitchee coupler (not shown), rotation of the supporter system 100 relative to the patient transporter 280, (with respect to the vertical axis relative to the ground) is inhibited and may be desirable in some implements or environments.

The same rotational inhibition can also be accomplished by substituting the circular cross-sectional hitcher coupler 132 with a hexagonal cross-sectional hitcher coupler 692 paired with a corresponding hexagonal cross-sectional female hitchee coupler (not shown). Other cross-sectional profiles may also be possible including rounded-shapes such as ovals and ellipses, and polygons such as pentagons and octagons. Hence, advantages of using a non-rounded cross-section includes limited swaying or fish-tailing of the supporter system 100 thereby improving stability as the patient transporter 280 is propelled from one location to another, especially when travelling on an incline.

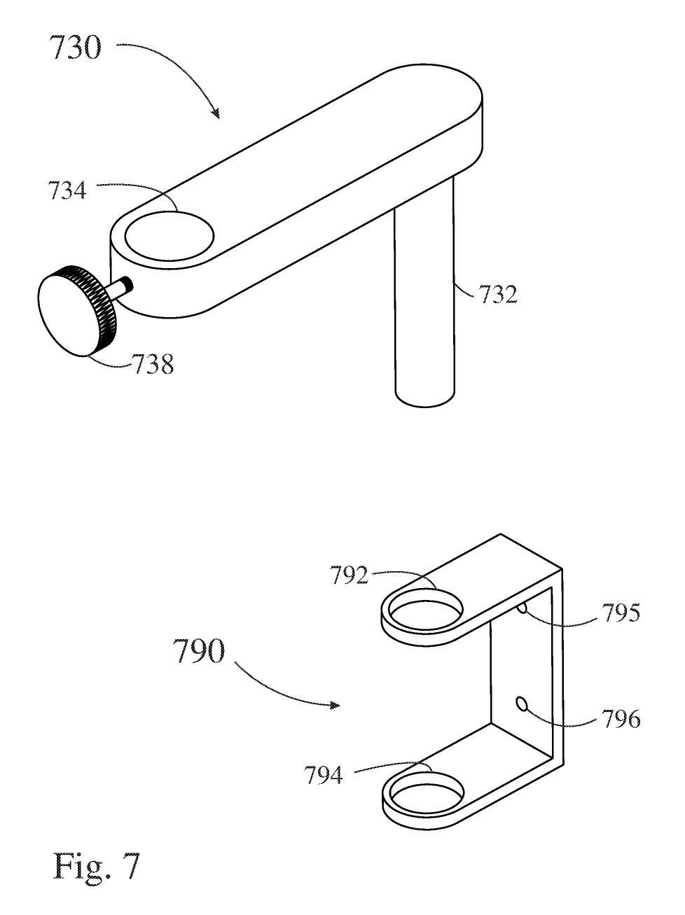

Referring to FIG. 7, it is also possible to adapt a conventional supporter system such as an infusion pump transport pole (not shown) and/or an incompatible patient transporter such as a rollable bed (not shown) by attaching retrofit hitcher assembly 730 to a main support structure of the conventional supporter system and attaching a retrofit hitchee assembly 790 to the previously incompatible patient transporter. This is accomplished by inserting the main support structure of the supporter system into the through-hole 734, and securing the hitcher assembly 730 by tightening the screw of threaded knob 738. In addition, an incompatible patient transporter can also be retrofitted by mounting hitchee assembly 790 at the appropriate location of the transporter using mounting screw holes 795, 796.

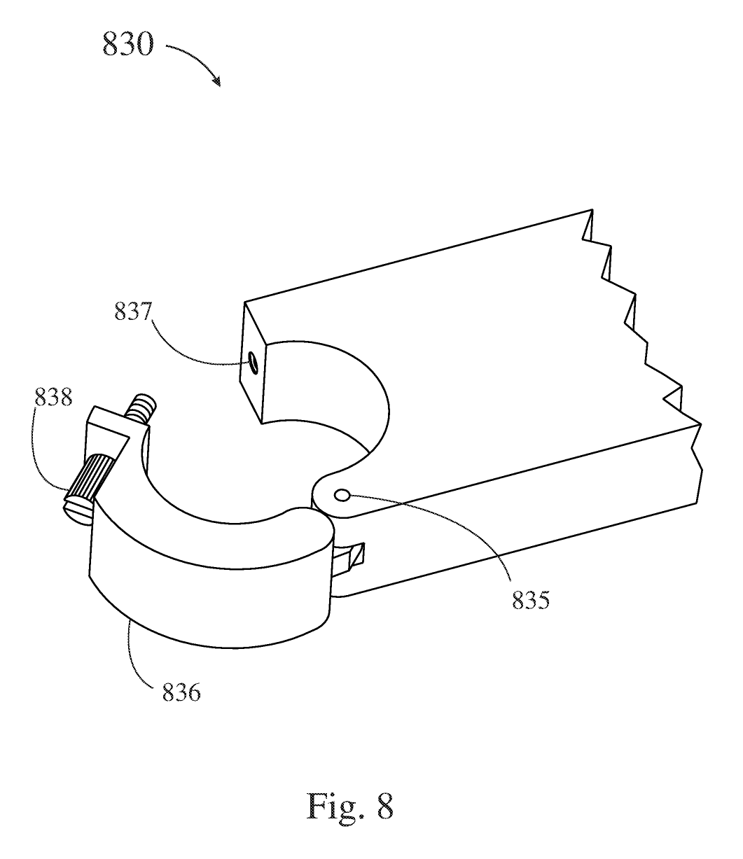

Alternatively, an exemplary clamp-like attachment as shown in FIG. 8 enables a hitcher assembly 830 to be easily attached to and detached from a mobile medical equipment supporter system (not shown). Such a hitcher assembly 830 is secured by (closing) pivoting the clamping ring 836 about pivot pin 835, inserting thumb screw 838 into a threaded hole 837, and tightening the resulting structure around a main support structure of supporter system.

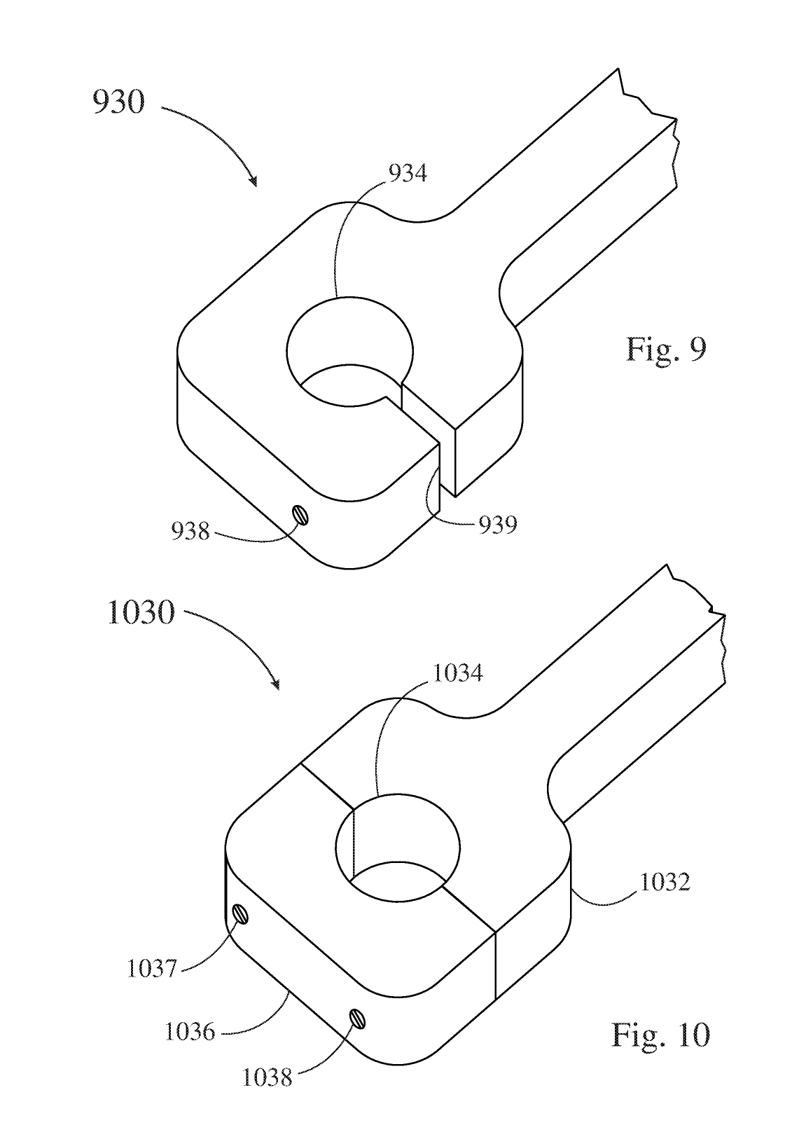

FIG. 9 shows a portion of an additional embodiment of a hitcher assembly 930 configured to be attached to a mobile medical equipment supporter system such as an infusion pump transport pole (not shown). This is accomplished by inserting the main support structure of the mobile medical support system into the split-ring 934, and securing the hitcher assembly 930 by tightening a screw 938 thereby narrowing the gap 939 and thereby reducing the circumference of the split-ring 934.

Referring now to FIG. 10, is yet another embodiment of a hitcher assembly 1030 suitable for attaching to a mobile medical supporter system (not shown). In this embodiment, the hitcher assembly is coupled to the main support structure by securing both halves of the semi-circle 1034 around the primary support structure, e.g., the pole, and then tightening screws 1037, 1038.

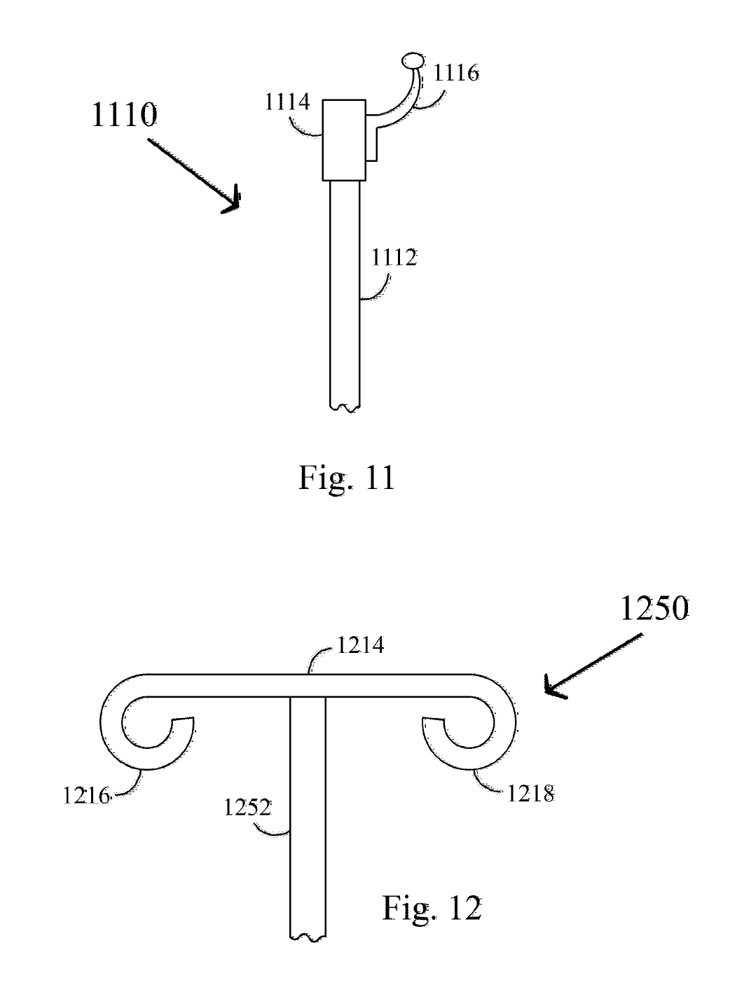

FIG. 11 is a side view showing an alternate embodiment of an attachment bar 1114 with one or more attachment point 1116, suitable for the mobile medical equipment supporter system 100. Similarly, FIG. 12 is a front view showing yet additional embodiment of an attachment bar 1214 with integral attachment points 1216, 1218 suitable for supporter system 100.

Other modifications are also contemplated in accordance with the present invention. For example, in some light-weight implementations, assuming hitcher coupler 132 can provide sufficient vertical stability via relying on the stability of hitchee coupler 292, it may be possible to provide mobility to a supporter system by using a single wheel positioned substantially underneath the main support structure. It is also possible to add hydraulics or springs to the main support structure to reduce the effort required to raise the mobile supporter system during the coupling and decoupling processes.

Further, in order to reduce the risks of unintentional decoupling of the supporter system 100 from the patient transporter 280, it is also possible, for example, to add spring-loaded ball detents to the hitcher coupler 132. Other possible “locking” techniques include ball detent pins and spring cotter pins.

In some embodiments there is the need for a mobile patient transporter to include an adjustable hitchee guide to have the ability to vary the position where a mobile medical equipment supporter system is secured to the mobile patient transporter. Additionally, it may be desirable to have more than one mobile medical equipment supporter system secured to the mobile patient transporter. The following embodiments in accordance with the present invention address these needs.

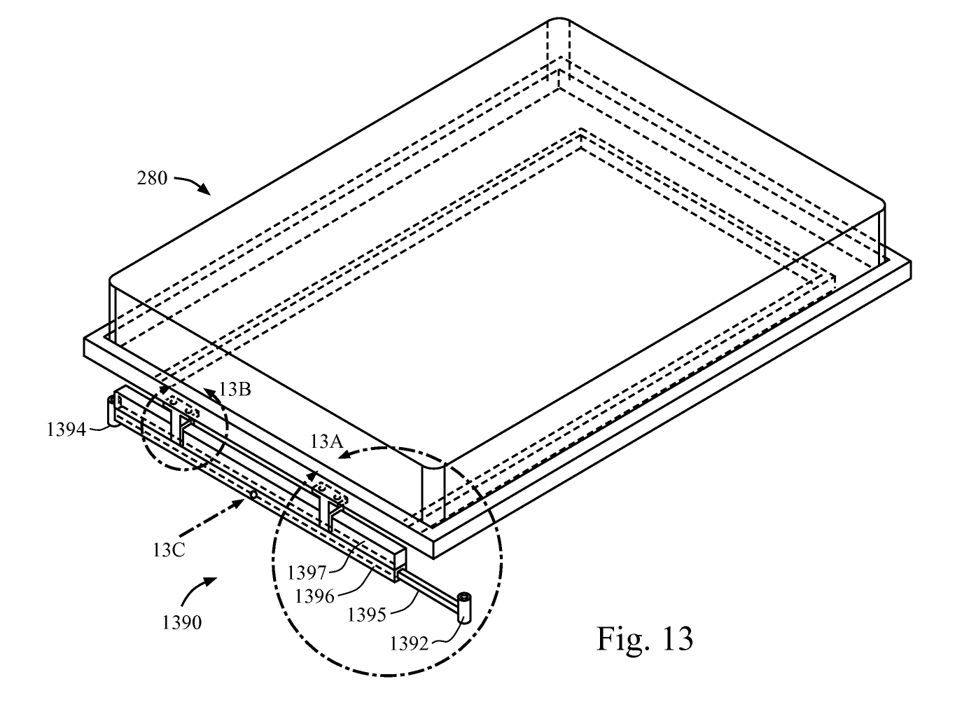

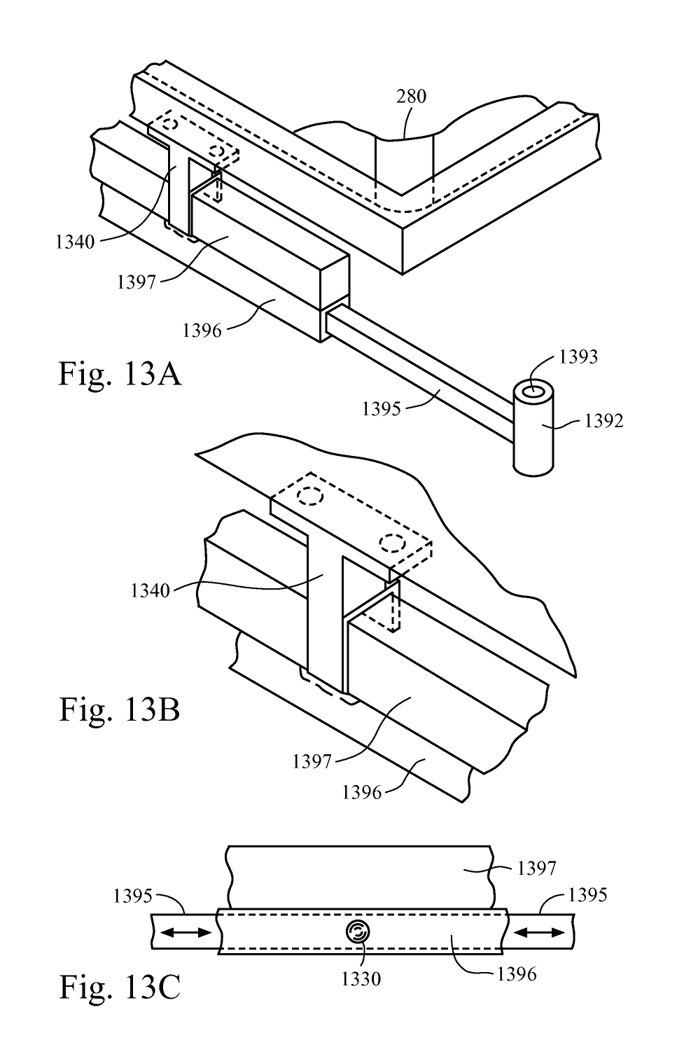

FIG. 13 illustrates one embodiment in which the position where the mobile medical equipment supporter system is secured to a mobile patient transporter 280 can be easily varied using an adjustable hitchee assembly 1390 is operatively connected to hitchee couplers 1392 and 1394 by a hitchee pole 1395. As shown in FIG. 13, the hitchee pole 1395 can be configured to move linearly inside a channel 1396. FIG. 13A is a blow-up of an edge portion of the adjustable hitchee assembly 1390. The hitchee coupler 1392 can have the shape of a hollow cylinder with a cylindrical slot 1393. Thus the female-hitchee coupler 1392 (in this exemplary case a tube shaped) can be configured to operatively mate with a corresponding male hitcher coupler (e.g., rod-shaped) of a mobile medical equipment supporter system (not shown).

The adjustable hitchee assembly 1390 includes a channel 1396 which can be mechanically coupled to a clearance beam 1397. The adjustable hitchee assembly 1390 can be easily attached to the mobile patient transporter 280 by a U-bracket 1340 as depicted in the blow-up portion of the adjustable hitchee assembly 1390 shown in FIG. 13B.

The hitchee pole 1395 can be configured to move linearly inside the channel 1396 to position the hitchee coupler 1392 in a desired position depending on the type of use of the mobile medical equipment supporter system. Once the desired position is found, the hitchee pole 1395 is locked in place inside the channel 1396 using a ball detent pin 1330 as shown in the blow-up portion of the adjustable hitchee assembly 1390 depicted in FIG. 13C. Other possible locking techniques, such as spring cotter pins, can also be used.

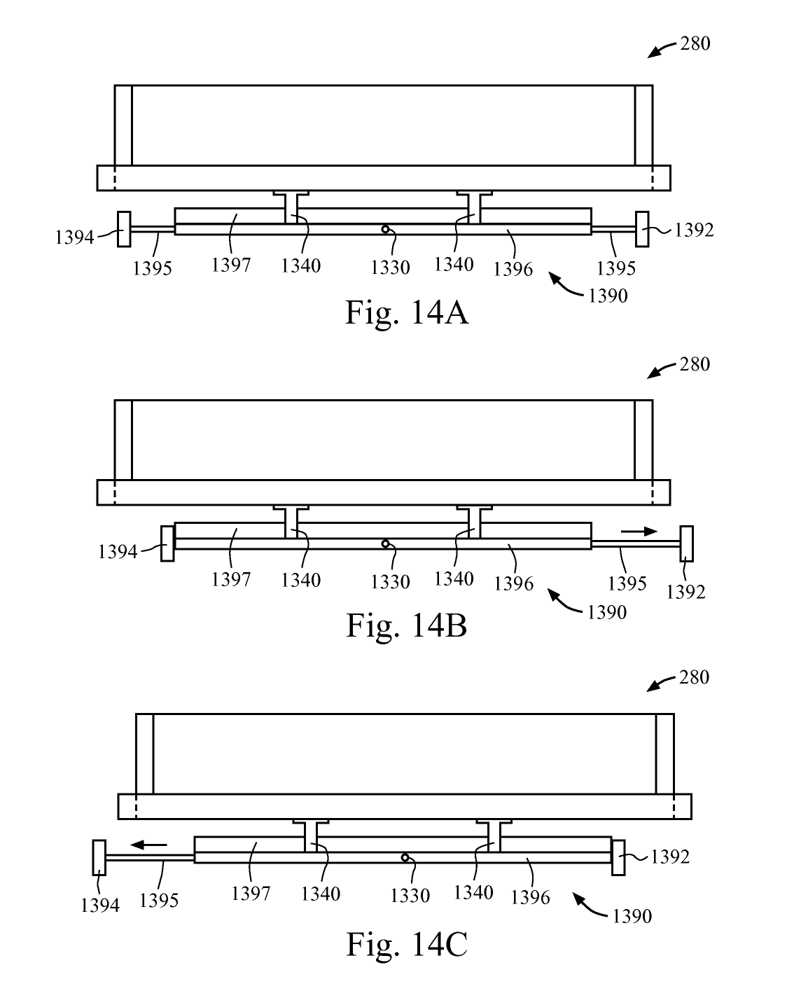

As shown in FIGS. 14A, 14B, and 14C, the hitchee assembly 1390 can have two hitchee couplers 1392 and 1394. FIG. 14A presents the position of the adjustable hitchee assembly 1390 when the system is not in use and no medical equipment supporter system is operatively connected to the mobile patient transporter 280 (such as a patient's bed or gurney). FIG. 14B presents the position of the adjustable hitchee assembly 1390 when the medical equipment supporter system (not shown) is operatively connected to left of the mobile patient transporter 280. FIG. 14C presents the position of the adjustable hitchee assembly 1390 when the medical equipment supporter system (not shown) is operatively connected to right of the mobile patient transporter 280.

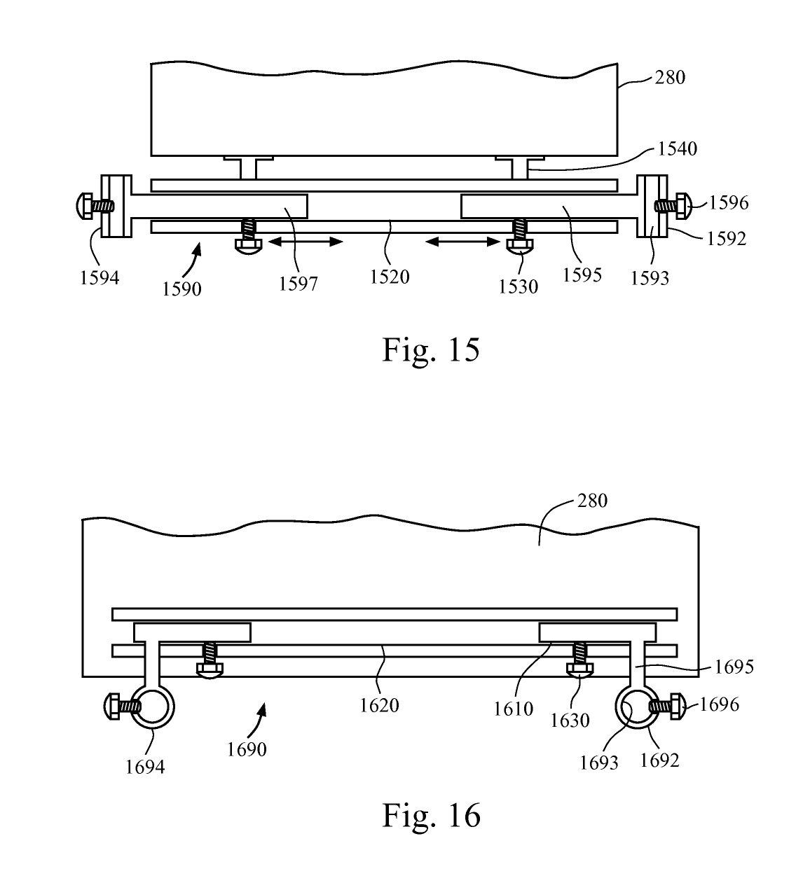

Another exemplary embodiment is illustrated using FIG. 15. In this embodiment an adjustable hitchee assembly 1590 can have two separate and independent hitchee couplers 1592 and 1594. The hitchee coupler 1592 is mechanically attached to a hitchee pole 1595 and the hitchee coupler 1594 is mechanically attached to a hitchee pole 1597. The separate hitchee poles 1595 and 1597 can be configured to each move linearly within a track 1520 to position the hitchee couplers 1592 and 1594 independently in desired positions depending on the type of use of the mobile medical equipment supporter systems (not shown) which are operatively connected to the adjustable hitchee assembly 1590. Once the desired position is found, the hitchee pole 1595, for example, can be locked in place inside the track 1520 by tightening at least one screw with a knob head 1530. A male hitcher coupler (not shown) of the mobile medical equipment supporter system can be configured to mate with the female hitchee coupler 1592 in the slot 1593 and can be easily secured inside, for example, by tightening at least one screw with a knob head 1596. Other possible locking techniques include ball detent pins and spring cotter pins. A similar arrangement can be used with the hitchee coupler 1594. Thus, the mobile medical equipment supporter system can be operatively connected on either side of the mobile patient transporter 280. Additionally, this embodiment allows two separate mobile medical equipment supporter systems to be operatively connected to the same mobile patient transporter 280.

FIG. 16 illustrates yet another exemplary embodiment. An adjustable hitchee assembly 1690 can be mounted underneath the mobile patient transporter 280, and thus saving the space around the mobile patient transporter (such as a patient's bed or gurney) and allowing for easy access of other medical instruments and equipment that are occasionally needed to be in close proximity to the patient. As shown in FIG. 16, a track 1620 mounted underneath the mobile patient transporter 280 can provide different independent positions for couplers 1692 and 1694. The position of the hitchee coupler 1692, for example, can be locked in place inside the track 1620 by tightening at least one screw with a knob head 1630 which when tightened can press against the guided section 1610 inside the track 1620. The hitchee coupler 1692, for example, is affixed to a hitchee pole 1695 which is mechanically coupled to the guided section 1610 inside the track 1620.

A male hitcher coupler of the mobile medical equipment supporter system (not shown) can be easily secured inside the female hitch coupler 1692 in the slot 1693, for example, by tightening at least one screw with a knob head 1696. A similar arrangement can be used with the hitchee coupler 1694. Thus, the mobile medical equipment supporter system can be operatively connected on either side of the mobile patient transporter 280. Additionally, this embodiment allows two separate mobile medical equipment supporter systems to be operatively connected to the same mobile patient transporter 280, if two mobile medical equipment supporter systems are needed to be operatively connected to the mobile patient transporter 280.

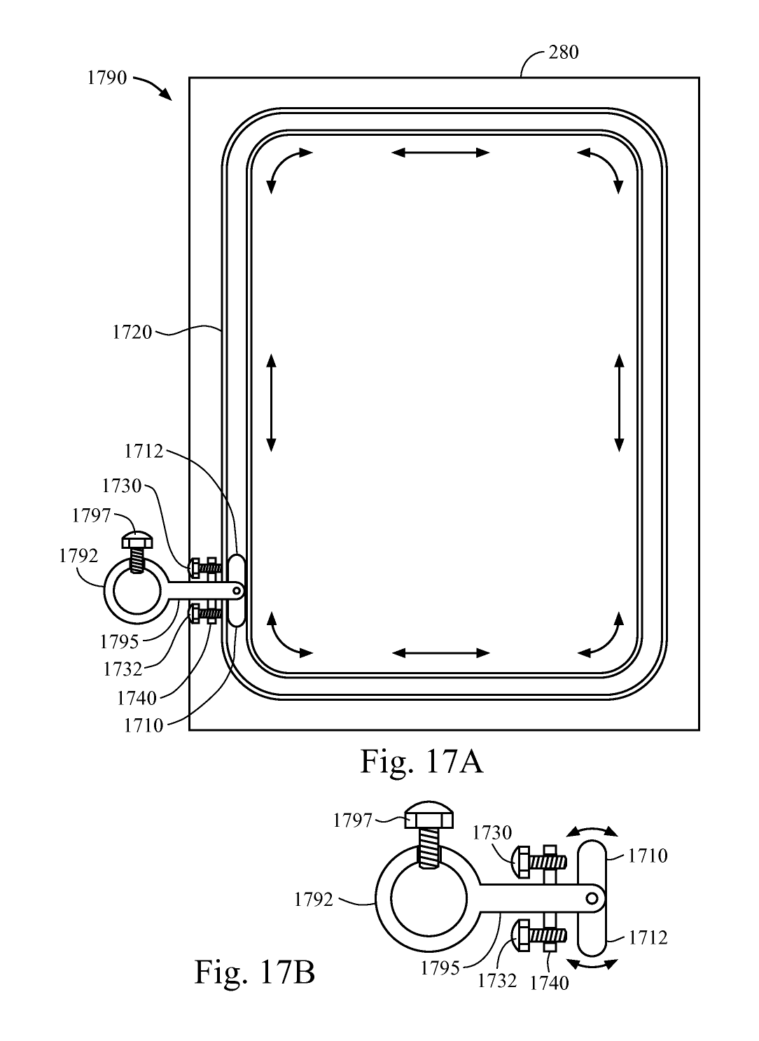

It is to be noted that in some cases the mobile medical equipment supporter systems are used to carry medical delivery devices, monitoring devices and medical instruments that have probes and leads that may need to be connected to different parts of the patient's body such as the head, the arms, or the legs. Thus, it is a desirable feature to have the adjustability of positioning these medical equipment and instruments as close to targeted part of the body. In yet another embodiment in accordance of the present invention addresses this need as illustrated in FIGS. 17A and 17B. In this embodiment an adjustable hitchee assembly 1790 includes a continuous racetrack 1720 which can be mounted underneath the mobile patient transporter 280 (such as underneath a patient's bed or gurney), and thus allowing for the mobile medical equipment supporter system to be positioned at any location around the mobile patient transporter 280. A hitchee coupler 1792 can be mechanically coupled to a hitchee pole 1795. Two guided sections 1710 and 1712 are pivoted to the hitchee pole 1795 and can be configured to travel along the racetrack 1720. They also can be configured to be locked at any desired position around the mobile patient transporter 280 by tightening two or more screws with a knob head 1730 and 1732 going through a plate 1740 with threaded round holes. When these two screws are tightened, they press against the outer circumference of the racetrack 1720 and thus locking the mobile medical equipment supporter system in a convenient position with respect to the patients to optimally use the medical equipment and instruments carried by the mobile medical equipment supporter system. Note that other possible locking techniques known to one skilled in the art can also be used such as ball detent pins or spring cotter pins, and twist locking mechanisms.

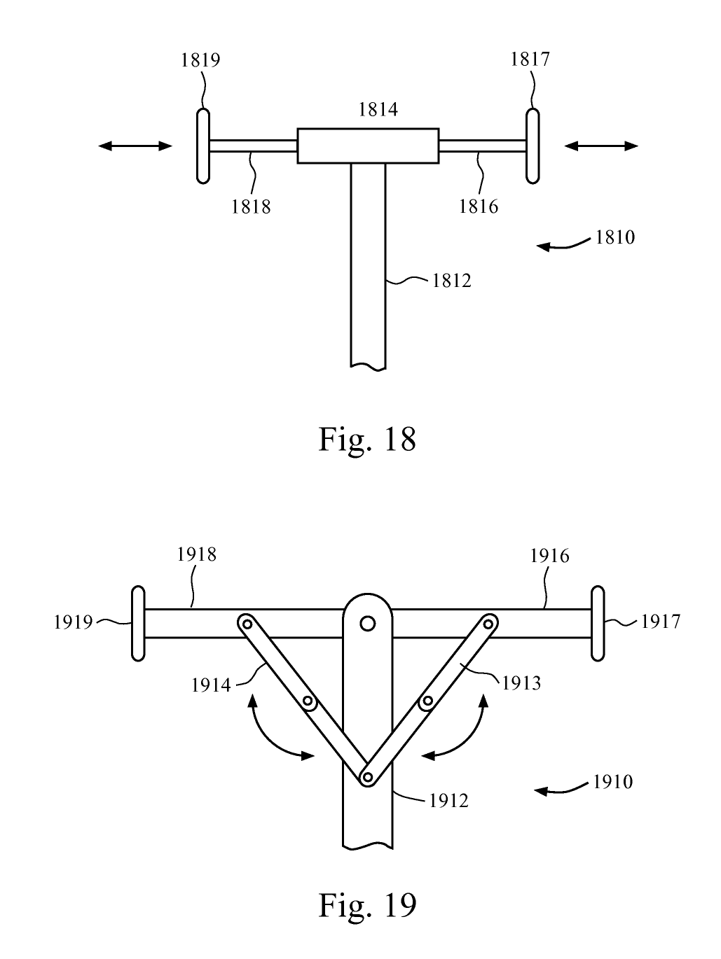

Referring now to FIGS. 18 and 19, illustrating exemplary upper portions 1810, 1910 for two additional embodiments of medical equipment supporters in accordance with the present invention. Upper portion 1810 includes a telescoping attachment structure having a T-top 1814, a pair of telescoping arms 1816, 1818 and corresponding pair of retainers 1817, 1819. Alternatively, upper portion 1910 includes a vertical support structure 1912, and a pair of collapsible arms 1916, 1918, a corresponding pair of hinged arm supports 1913, 1914 and a corresponding pair of retainers 1917, 1919. Note that attachment points (not shown in FIGS. 18 and 19) similar to those of the embodiments described above can be attached to arms 1816, 1818, 1916, 1918.

While this invention has been described in terms of several embodiments, there are alterations, modifications, permutations, and substitute equivalents, which fall within the scope of this invention. Many of these modifications can also be practiced alone or in different combinations.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A hitching adapter system for configuring a mobile medical equipment supporter system to operate with a mobile patient transporter for a patient, the mobile transporter having a main post and a wheeled base, and wherein the mobile medical equipment supporter system is configured to support a medical delivery device or a medical monitoring device for the patient, the hitching adapter system comprising:
a hitchee assembly for a mobile patient transporter, the hitchee assembly including:
a hitchee coupler configured to mate with a corresponding hitcher coupler of a medical equipment supporter system; and
an adjustable hitchee guide configured to adjustably secure the hitchee coupler to the mobile patient transporter.

2. The hitching adapter system of claim 1 wherein the adjustable hitchee guide includes a guide tube and wherein the hitchee coupler is configured to telescope with respect to the guide tube.

3. The hitching adapter system of claim 2 further comprising a second hitchee coupler configured to mate with the hitcher coupler of the medical equipment supporter system, and wherein the second hitchee coupler is further configured to telescope with respect to the guide tube.

4. The hitching adapter system of claim 1 wherein the adjustable hitchee guide includes a guide track, wherein the hitchee coupler is configured to slide along the guide track and wherein the hitchee coupler is further configured to be secured at an appropriate position along the guide track.

5. A hitching adapter system for configuring a mobile medical equipment supporter system to operate with a mobile patient transporter for a patient, the mobile transporter having a main post and a wheeled base, and wherein the mobile medical equipment supporter system is configured to support a medical delivery device or a medical monitoring device for the patient, the hitching adapter system comprising:
a hitcher assembly for a mobile medical equipment supporter system, the hitcher assembly including:
a fixture configured to secure the adapter to a main support structure of the supporter system; and
a hitcher coupler; and
a hitchee assembly for a mobile patient transporter, the hitchee assembly including:
a hitchee coupler configured to mate with the hitcher coupler of the medical equipment supporter system; and
an adjustable hitchee guide configured to adjustably secure the hitchee coupler to the mobile patient transporter.

6. The hitching adapter system of claim 5 wherein the adjustable hitchee guide includes a guide tube and wherein the hitchee coupler is configured to telescope with respect to the guide tube.

7. The hitching adapter system of claim 6 further comprising a second hitchee coupler configured to mate with the hitcher coupler of the medical equipment supporter system, and wherein the second hitchee coupler is further configured to telescope with respect to the guide tube.

8. The hitching adapter system of claim 5 wherein the adjustable hitchee guide includes a guide track, wherein the hitchee coupler is configured to slide along the guide track and wherein the hitchee coupler is further configured to be secured at an appropriate position along the guide track.

9. The hitching adapter system of claim 5 wherein the hitcher coupler is male and the hitchee coupler is female.

10. The hitching adapter system of claim 5 wherein both the hitcher coupler and the hitchee coupler have circular cross-sectional profiles.
